(19) United States
(12) Patent Application Publication
(10) Pub. No.: US 2011/0157618 A1
(43) Pub. Date: Jun. 30, 2011

(54) IMAGE DATA TRANSMISSION APPARATUS THAT TRANSMITS IMAGE DATA TO DESIGNATED DESTINATION, CONTROL METHOD, AND STORAGE MEDIUM

(75) Inventor: Masahiro ODAIRA, Kawasaki-shi (JP)

(73) Assignee: CANON KABUSHIKI KAISHA, Tokyo (JP)

(21) Appl. No.: 12/973,055

(22) Filed: Dec. 20, 2010

(30) Foreign Application Priority Data
Dec. 28, 2009 (JP) 2009-297682

(51) Int. Cl. G06K 15/02; G06F 3/12

(52) U.S. Cl. 358/1.14; 358/1.15

(57) ABSTRACT

An image data transmission apparatus that can reliably transmit image data to an archiving destination before transmitting the image data to a set destination. A destination indicative of an archiving destination that manages image data generated by a scanner unit is set, and the image data is transmitted to the archiving destination. A destination to which the image data is to be transmitted is set, and the image data is transmitted to the destination. When the image data has been successfully transmitted to the archiving destination, the image data is transmitted to the destination.

### BACKGROUND OF THE INVENTION

1. Field of the Invention

The present invention relates to an image data transmission apparatus that transmits image data to a designated destination, a control method, and a computer-readable storage medium storing a program for causing a computer to implement the method.

2. Description of the Related Art

Conventionally, there has been known an image data transmission apparatus (such as a multifunctional peripheral) having a function of automatically transmitting image data read off an original to an archiving destination as well as a user-designated destination with the objective of preventing information leakage and unauthorized use of the transmitted image data. An archiving destination means a specific destination such as an administrator or an administrative server which controls the image transmission apparatus. Further, there has been proposed an image data transmission apparatus which inhibits deletion of a destination indicative of an archiving destination in order to more reliably transmit image data to the archiving destination (see, for example, Japanese Patent Registration No. 3701523).

The conventional image transmission apparatuses described above, however, have the problem that even when an error has occurred during transmission of image data to a destination indicative of an archiving destination, the image data can be transmitted to a user-designated destination, and therefore, the image data transmitted to the user-designated destination cannot be managed and backed up at the archiving destination.

### SUMMARY OF THE INVENTION

The present invention provides an image data transmission apparatus that can reliably transmit image data to an archiving destination before transmitting the image data to a set destination, a control method, and a computer-readable storage medium storing a program for causing a computer to implement the method.

Accordingly, a first aspect of the present invention provides an image data transmission apparatus comprising a generation unit configured to generate image data, a first setting unit configured to set a destination indicative of an archiving destination that manages the image data, a first transmission unit configured to transmit the image data generated by the generation unit to the archiving destination set by the first setting unit, a second setting unit configured to set a destination to which the image data is to be transmitted, a second transmission unit configured to transmit the image data generated by the generation unit to the destination set by the second setting unit, and a control unit configured to, when the image data has been successfully transmitted to the archiving destination by the first transmission unit, cause the second transmission unit to transmit the image data to the destination.

Accordingly, a second aspect of the present invention provides a control method for an image data transmission apparatus having a generation unit that generates image data, comprising a first setting step of setting a destination indicative of an archiving destination that manages the image data, a first transmission step of transmitting the image data generated by the generation unit to the archiving destination set in the first setting step, a second setting step of setting a destination to which the image data is to be transmitted, a second transmission step of transmitting the image data generated by the generation unit to the destination set in the second setting step, and a control step of, when the image data has been successfully transmitted to the archiving destination in the first transmission step, transmitting the image data to the destination in the second transmission step.

Accordingly, a third aspect of the present invention provides a computer-readable non-transitory storage medium storing a program for causing a computer to execute a control method for an image data transmission apparatus having a generation unit that generates image data, the control method comprising a first setting step of setting a destination indicative of an archiving destination that manages the image data, a first transmission step of transmitting the image data generated by the generation unit to the archiving destination set in the first setting step, a second setting step of setting a destination to which the image data is to be transmitted, a second transmission step of transmitting the image data generated by the generation unit to the destination set in the second setting step, and a control step of, when the image data has been successfully transmitted to the archiving destination in the first transmission step, transmitting the image data to the destination in the second transmission step.

According to the present invention, because image data is transmitted to a set destination when the image data has been successfully transmitted to an archiving destination, the image data can be reliably transmitted to the archiving destination before the image data is transmitted to the set destination.

Further features of the present invention will become apparent from the following description of exemplary embodiments (with reference to the attached drawings).

### BRIEF DESCRIPTION OF THE DRAWINGS

FIG. 1 is a block diagram schematically showing an arrangement of an image data transmission apparatus according to a first embodiment of the present invention.

FIG. 2 is a flowchart of a process carried out to designate a transmission job.

FIGS. 3A and 3B are flowcharts of a process carried out to designate a transmission job according to a second embodiment of the present invention.

FIG. 4 is a flowchart of a process carried out to designate a transmission job according to a third embodiment of the present invention.

FIGS. 5A to 5C are flowcharts of a process carried out to designate a transmission job according to a fourth embodiment of the present invention.

FIG. 6 is a diagram showing transmission jobs, an archiving destination transmission queue, a user-designated destination transmission queue, and an order in which image data is transmitted.

FIG. 7 is a diagram showing whether or not image data is to be transmitted to an archiving destination, a destination indicative of an archiving destination, and whether or not priority is given to an archiving destination.

### DESCRIPTION OF THE EMBODIMENTS

The present invention will now be described in detail with reference to the drawings showing embodiments thereof.

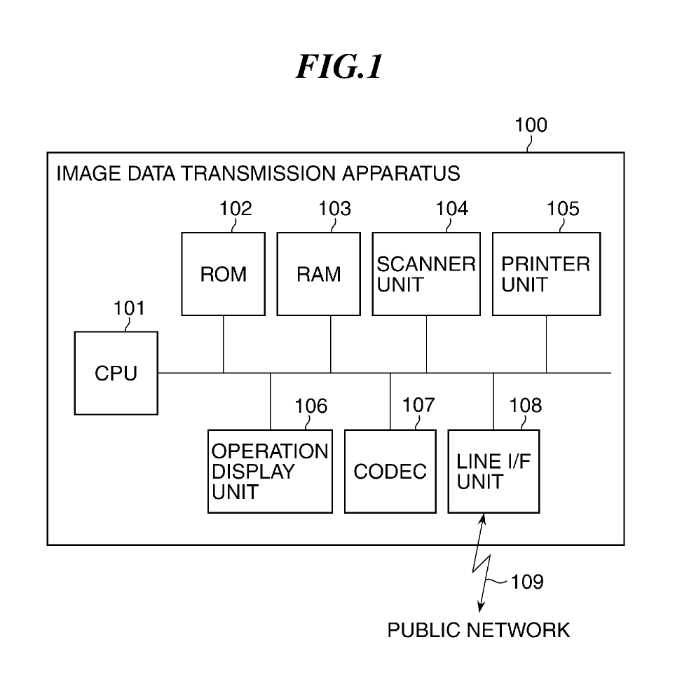

FIG. 1 is a block diagram showing an arrangement of an image data transmission apparatus according to a first embodiment of the present invention.

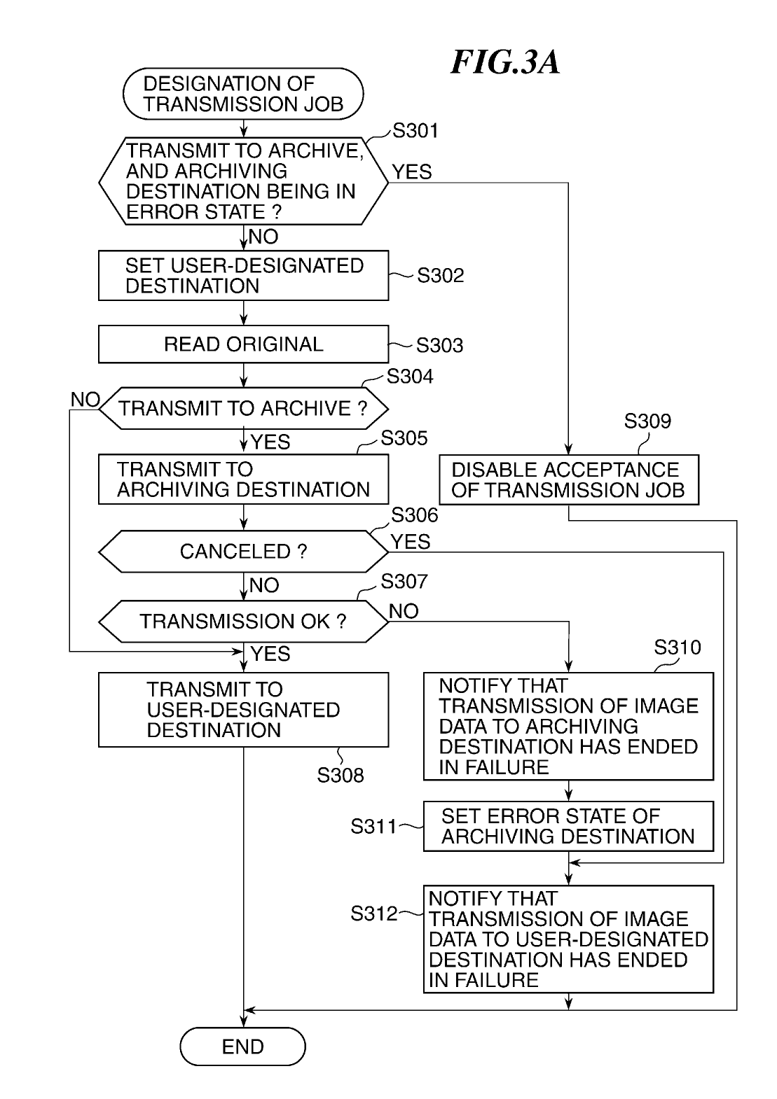

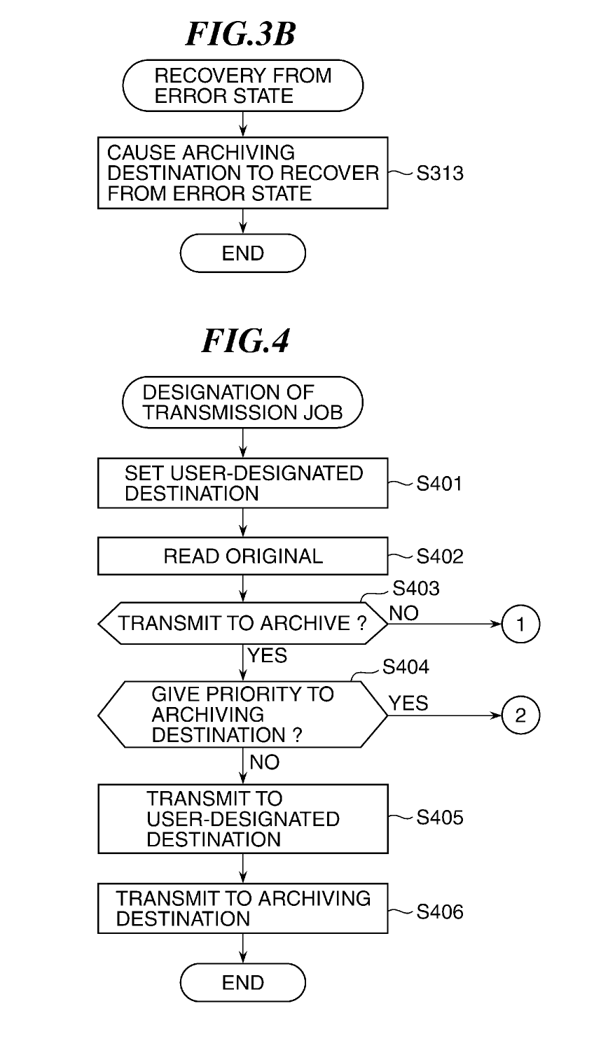

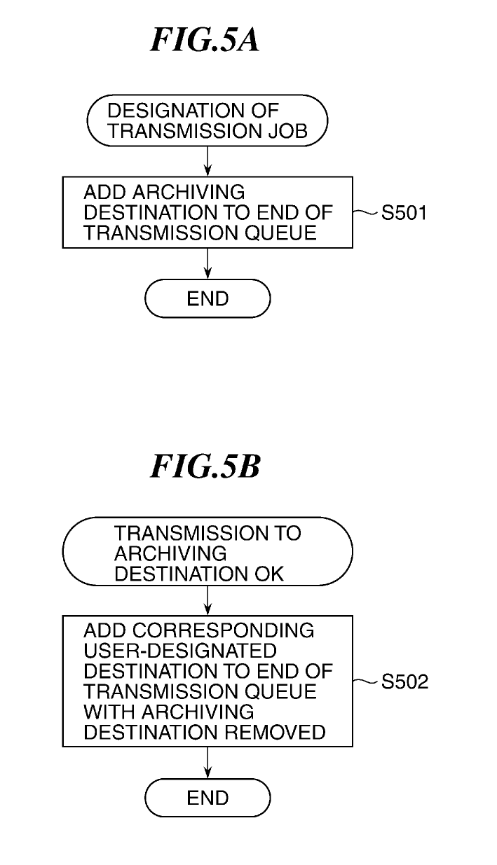

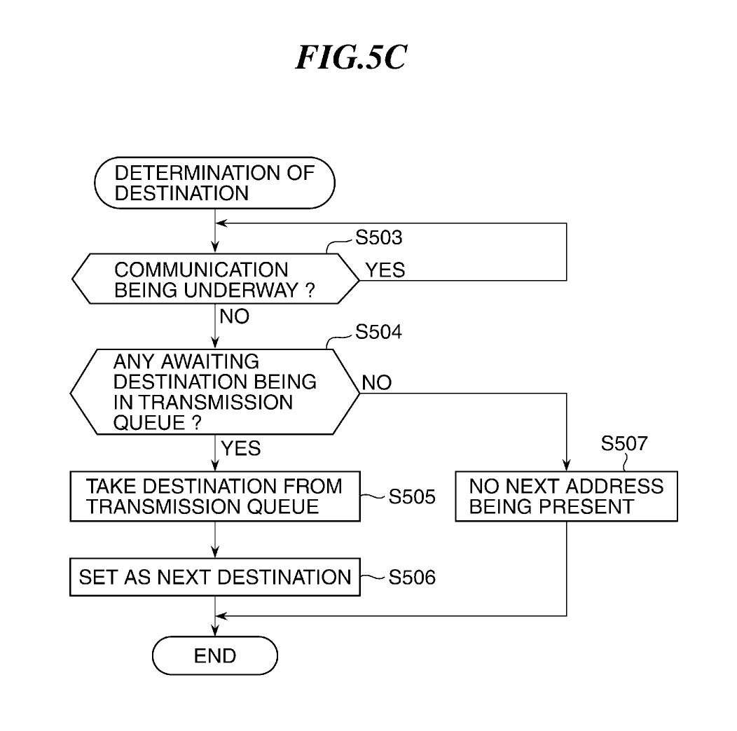

Referring to FIG. 1, the image data transmission apparatus 100 is configured as, for example, a multifunctional peripheral, and has a CPU 101, a ROM 102, a RAM 103, a scanner unit 104, a printer unit 105, an operation display unit 106, a CODEC 107, and a line I/F unit 108. The CPU 101 is a system controller, which controls the overall operation of the image data transmission apparatus 100. By executing control programs, the CPU 101 carries out processes in flowcharts of FIG. 1 (the first embodiment), FIGS. 3A and 3B (a second embodiment), FIG. 4 (a third embodiment), and FIGS. 5A, 5B, and 5C (a fourth embodiment).

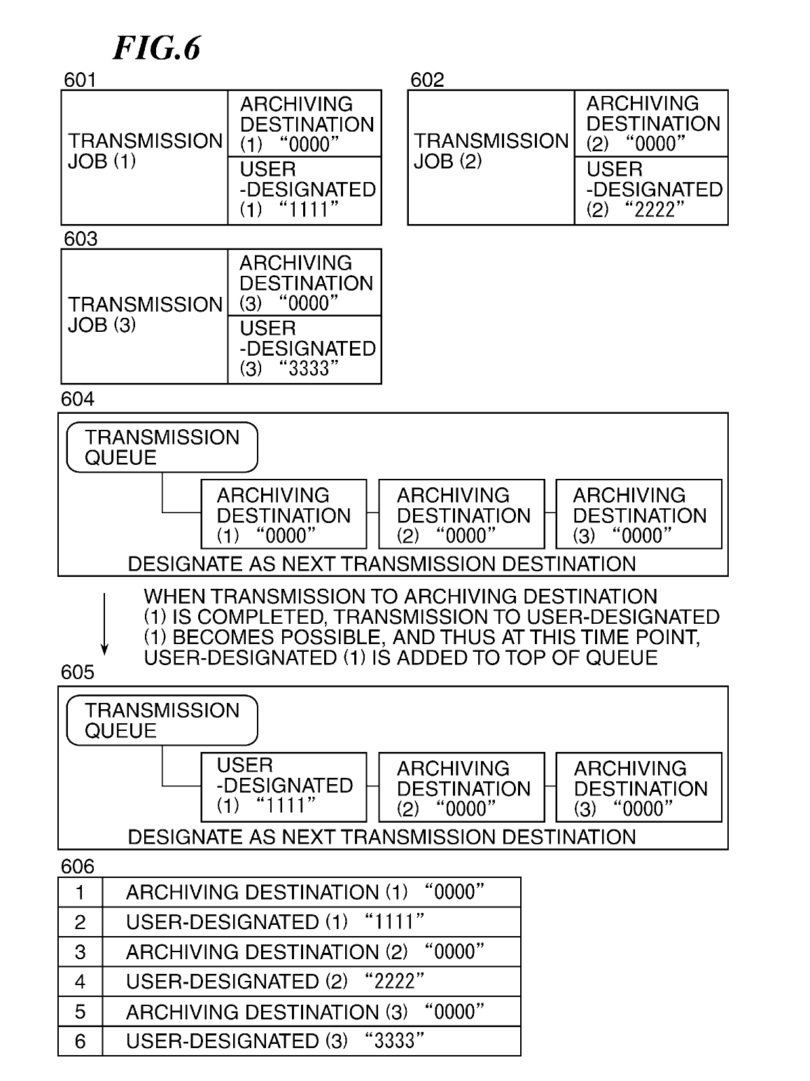

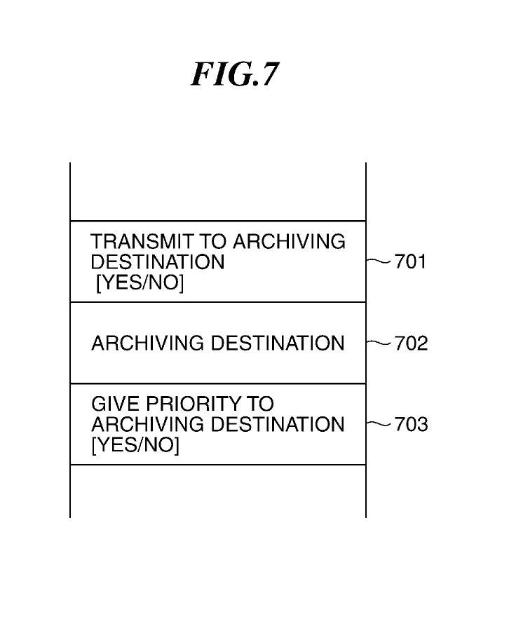

The ROM 102 stores control programs. The control programs are programs for causing the CPU 101 to carry out processes in flowcharts, described later (processes to designate a transmission job). Stored in the RAM 103 are control programs, program control variables, various working buffers, managed data, transmission queues (see FIG. 6), setting values registered by a user who uses the image data transmission apparatus 100 (see FIG. 7), and so on. The transmission queues and the setting values (whether or not image data is to be transmitted to an archiving destination, a destination indicative of an archiving destination, and whether or not priority is given to an archiving destination) will be described later in detail.

The scanner unit 104 is comprised of an original mounting unit, an image sensor (such as a CCD or a contact image sensor), an original conveying mechanism (not shown), and so on. The scanner unit 104 causes the original conveying mechanism to convey an original placed on the original mounting unit to a reading position, and causes the image sensor to optically read an image on the original and convert the image into electric image data (generate image data). The printer unit 105 prints an image on a recording sheet based on image data read off an original by the scanner unit 104, image data received from an external device by the image data transmission apparatus 100, or file data stored in the RAM 103.

The operation display unit 106 is comprised of a keyboard, a touch panel, an LCD, an LED, and so on, and is used for the user to perform various input operations (such as an input operation for inputting a destination to which image data is to be transmitted), and produce various displays. The CODEC (coder decoder) 107 is a module that carries out coding and decoding using JBIG, JPEG, and so on, and carries out compression and decompression of image data in conformity with predetermined standards. The line interface (I/F) unit 108 is comprised of a modem (a modulator and demodulator), an NCU (network control unit), and so on, and transmits and receives data to and from an external device by facsimile via a public network 109.

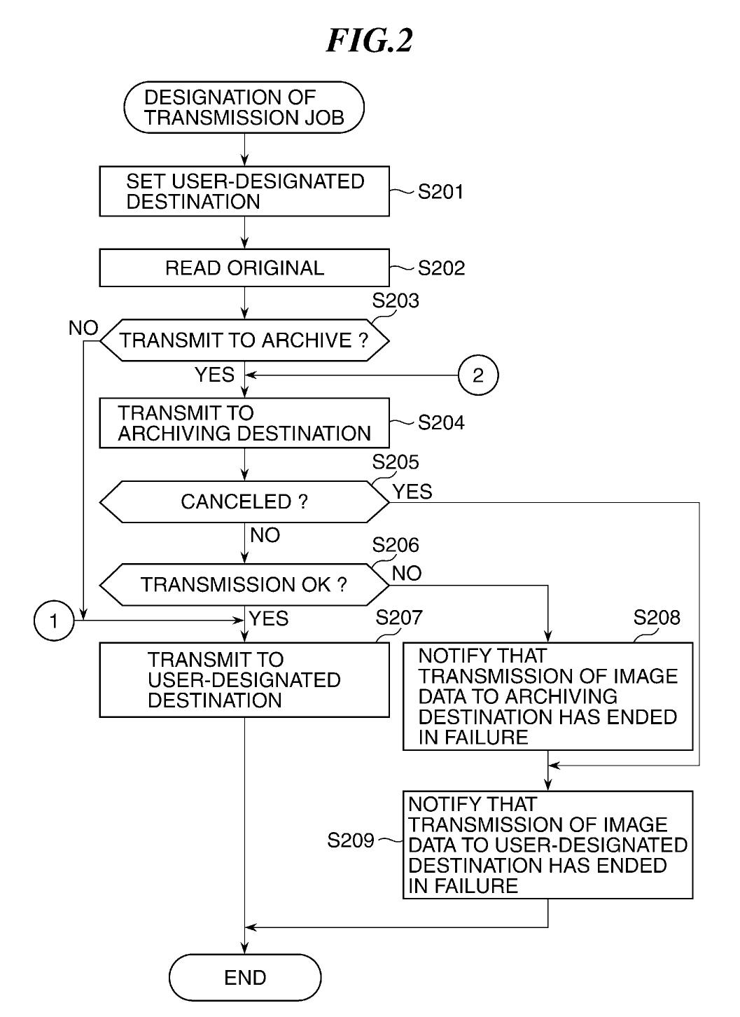

Referring next to FIGS. 2 and 7, a description will be given of how the image data transmission apparatus according to the present embodiment arranged as described above operates.

FIG. 2 is a flowchart of a process carried out to designate a transmission job according to the present embodiment. FIG. 7 is a diagram showing whether or not image data is to be transmitted to an archiving destination, a destination indicative of an archiving destination, and whether or not priority is given to an archiving destination.

Referring to FIG. 2, the CPU 101 of the image data transmission apparatus 100 sets a user-designated destination input via the operation display unit 106 by the user as an image data destination (step S201: a second setting unit). Then, the CPU 101 causes the scanner unit 104 to read an original placed on the original mounting unit, and stores the read image data in the RAM 103 (step S202). Then, the CPU 101 determines whether or not to transmit the image data to an archiving destination (a specific destination for an administrator who controls the image data transmission apparatus and the image data) (step S203). The setting as to whether or not to transmit the image data to the archiving destination (a first setting unit) is stored in advance as a setting value 701 (see FIG. 7) in the RAM 103, and the CPU 101 makes the above determination by referring to the setting value 701.

When determining to transmit the image data to the archiving destination, the CPU 101 causes the line I/F unit 108 to transmit the image data read off the original in the step S202 to the archiving destination (step S204: a first transmission unit). A destination indicative of the archiving destination is stored in advance as a setting value 702 (see FIG. 7) in the RAM 103, and the CPU 101 transmits the image data to the destination indicative of the archiving destination stored as the setting value 702. It should be noted that in the step S204, because the image data is transmitted to the destination that is not designated by the user, the user may misunderstand that the image data is being transmitted to an incorrect destination. Thus, in the step S204, a message saying that the image data is being transmitted to the archiving destination may be displayed on the operation display unit 106. This can prevent the user from misunderstanding that the image data is being transmitted to an incorrect destination. On this occasion, by displaying a message such as “now being archived” on the operation display unit 106 without displaying information that can identify the destination indicative of the archiving destination (such as a telephone number) on the operation display unit 106, the archiving destination can be prevented from being identified by general users.

Then, the CPU 101 determines whether or not transmission of the image data to the archiving destination in the step 204 has been canceled through operation by the user via the operation display unit 106 (step S205). When determining that transmission of the image data to the archiving destination has not been canceled, the CPU 101 determines whether or not transmission of the image data to the archiving destination has normally (successfully) completed (step S206). When determining that transmission of the image data to the archiving destination has normally completed, the CPU 101 causes the line I/F unit 108 to transmit the image data read off the original in the step S202 to the user-designated destination set in the step S201 (step S207: a second transmission unit). As a result, the CPU 101 terminates the present process.

When determining not to transmit the image data to the archiving destination in the step S203, the CPU 101 causes the line I/F unit 108 to transmit the image data read off the original in the step S202 to the user-designated destination set in the step S201 (step S207). As a result, the CPU 101 terminates the present process.

When determining in the step S205 that transmission of the image data to the archiving destination has been canceled, the CPU 101 notifies the user that the image data could not be transmitted to the user-designated destination (step S209). As a result, the CPU 101 terminates the present process.

When determining in the step S206 that the image data has not been normally transmitted to the archiving destination (an error has occurred), the CPU 101 notifies the user via the operation display unit 106 that the image data could not be transmitted to the archiving destination (step S208). Then, the CPU 101 notifies the user via the operation display unit 106 that the image data could not be transmitted to the user-designated destination (step S209). As a result, the CPU 101 terminates the present process.

It should be noted that although in the present embodiment, the notification in the step S208 that the image data could not be transmitted to the archiving destination and the notification in the step S209 that the image data could not be transmitted to the user-designated destination are displayed on the operation display unit 106, the present invention is not limited to this, but the printer unit 105 may print out notification results as reports.

As described above in detail, according to the present embodiment, image data is transmitted to a user-designated destination only when the image data has been successfully transmitted to a destination indicative of an archiving destination. Thus, image data can be reliably transmitted to a destination indicative of an archiving destination before the image data is transmitted to a user-designated destination.

Moreover, when transmission of image data to an archiving destination has not normally completed, the image data is not transmitted to a user-designated destination. Thus, image data can be prevented from being transmitted to a destination without ensuring that the image data is reliably stored at an archiving destination.

The second embodiment of the present invention differs from the first embodiment described above in respects described below with reference to FIGS. 3A and 3B. Other elements of the present embodiment are identical with the corresponding ones of the first embodiment described above (FIG. 1), and therefore, description thereof is omitted.

FIGS. 3A and 3B are flowcharts of a process carried out to designate a transmission job according to the present embodiment.

Referring to FIGS. 3A and 3B, the CPU 101 of the image data transmission apparatus 100 determines whether or not there is a setting that image data is to be transmitted to an archiving destination, and the archiving destination is in an error state (step S301). When determining that there is a setting that image data is to be transmitted to an archiving destination, and the archiving destination is in an error state, the CPU 101 disables acceptance of a transmission job by the image data transmission apparatus 100 (step S309), and terminates the present process. When determining that there is a setting that image data is not to be transmitted to an archiving destination, and the archiving destination is not in an error state, the CPU 101 sets a user-designated destination input by the user via the operation display unit 106 as an image data destination (step S302).

Then, the CPU 101 causes the scanner unit 104 to read an original placed on the original mounting unit, and stores the read image data in the RAM 103 (step S303). Then, the CPU 101 determines whether or not to transmit the image data read off the original to an archiving destination (step S304). When determining to transmit the image data to the archiving destination, the CPU 101 causes the line I/F unit 108 to transmit the image data read off the original in the step S303 to the archiving destination (step S305).

Then, the CPU 101 determines whether or not transmission of the image data to the archiving destination has been canceled (step S306). When determining that transmission of the image data to the archiving destination has not been canceled, the CPU 101 determines whether or not the image data has been normally transmitted to the archiving destination (step S307). When determining that transmission of the image data to the archiving destination has normally completed, the CPU 101 causes the line I/F unit 108 to transmit the image data read off the original in the step S303 to the user-designated destination set in the step S302 (step S308). As a result, the CPU 101 terminates the present process.

When determining not to transmit the image data to the archiving destination in the step S304, the CPU 101 causes the line I/F unit 108 to transmit the image data read off the original in the step S303 to the user-designated destination set in the step S302 (step S308). As a result, the CPU 101 terminates the present process.

When determining in the step S306 that transmission of the image data to the archiving destination has been canceled, the CPU 101 notifies the user via the operation display unit 106 that the image data could not be transmitted to the user-designated destination (step S312). As a result, the CPU 101 terminates the present process.

When determining in the step S307 that transmission of the image data to the archiving destination has not normally completed, the CPU 101 notifies the user via the operation display unit 106 that the image data could not be transmitted to the archiving destination (step S310). Then, the CPU 101 makes a setting, in the RAM 103, to the effect that the archiving destination is in an error state (step S311: a third setting unit).

For the present and subsequent transmission jobs, the CPU 101 determines in the step S301 that the archiving destination is in an error state. Also, in response to an operation instruction from the user via the operation display unit 106, the CPU 101 causes the archiving destination to recover from the error state (step S313). Then, the CPU 101 notifies the user via the operation display unit 106 that the image data could not be transmitted to the user-designated destination (step S312). As a result, the CPU 101 terminates the present process.

As described above in detail, according to the present embodiment, the effects obtained by the first embodiment described above can be obtained, and in addition to this, when it is known in advance that image data cannot be transmitted to an archiving destination, acceptance of a transmission job itself can be disabled.

The third embodiment of the present invention differs from the first embodiment described above in respects described below with reference to FIG. 4. Other elements of the present embodiment are identical with the corresponding ones of the first embodiment described above (FIG. 1), and therefore, description thereof is omitted.

FIG. 4 is a flowchart of a process carried out to designate a transmission job according to the present embodiment.

Referring to FIG. 4, the CPU 101 of the image data transmission apparatus 100 sets a user-designated destination input via the operation display unit 106 by the user as a image data destination (step S401). Then, the CPU 101 causes the scanner unit 104 to read an original placed on the original mounting unit, and stores the read image data in the RAM 103 (step S402). Then, the CPU 101 determines whether or not to transmit the image data to an archiving destination (step S403).

When determining to transmit the image data to the archiving destination, the CPU 101 determines whether or not to give priority to transmission of the image data to the archiving destination (step S404). The setting as to whether or not to give priority to transmission of the image data to the archiving destination (a fourth setting unit) is stored in advance as a setting value 703 (see FIG. 7) in the RAM 103, and the CPU 101 makes the above determination by referring to the setting value 703. When determining not to give priority to transmission of the image data to the archiving destination, the CPU 101 transmits the image data to the user-designated destination (step S405), and after that, transmits the image data to the archiving destination (step S406).

When determining not to transmit the image data to the archiving destination in the step S403, the CPU 101 proceeds the process to the step S207 in FIG. 2. When determining in the step S404 to give priority to transmission of the image data to the archiving destination, the CPU 101 proceeds the process to the step S204 in FIG. 2.

It should be noted that the setting as to whether or not to give priority to transmission of the image data to the archiving destination may be made only by the administrator of the image data transmission apparatus 100, not by the user.

As described above in detail, according to the present embodiment, the user can make a setting as to whether or not to give higher priority to transmission of image data to an archiving destination than to transmission of image data to a user-designated destination.

The fourth embodiment of the present invention differs from the first embodiment described above in respects described below reference to FIGS. 5A, 5B, and 5C, and FIG. 6. Other elements of the present embodiment are identical with the corresponding ones of the first embodiment described above (FIG. 1), and therefore, description thereof is omitted.

FIGS. 5A, 5B, and 5C are flowcharts of a process carried out to designate a transmission job according to the present embodiment. FIG. 6 is a diagram showing transmission jobs, an archiving destination transmission queue, a user-designated destination transmission queue, and an order in which image data is transmitted.

Referring to 5A, 5B, and 5C, when the user designates a transmission job via the operation display unit 106, the CPU 101 of the image transmission apparatus 100 adds a destination indicative of an archiving destination to the end of a transmission queue in the RAM 103 (step S501). For example, when a plurality of jobs consisting of a transmission job (1), a transmission job (2), and a transmission job (3) are designated in this order as shown in 601, 602, and 603 of FIG. 6, a destination indicative of an archiving destination is added as the next destination to the end of a transmission queue as shown in 604 of FIG. 6.

When image data has been normally transmitted to the archiving destination, the CPU 101 adds the corresponding user-designated destination to the end of the transmission queue with the destination indicative of the archiving destination removed (step S502). For example, as shown in 605 of FIG. 6, when image data has been normally transmitted to an archiving destination (1), a user-designated destination (1) is added to the top of a transmission queue because there is no other user-designated destination in the transmission queue.

Then, the CPU 101 determines whether or not the image transmission apparatus 100 is now communicating with the archiving destination (step S503). When determining that the image transmission apparatus 100 has completed one communication with the archiving destination (a communication corresponding to the transmission job), the CPU 101 determines whether or not in the transmission queue, there is any destination to which image data has not been transmitted (any destination awaiting image data transmission) (step S504).

When determining that in the transmission queue, there is no destination awaiting image data transmission, the CPU 101 determines that there is no destination to which image data is to be transmitted next (step S507), and terminates the present process. When determining that in the transmission queue, there is any destination awaiting image data transmission, the CPU 101 takes a transmission destination from the top of the transmission queue (step S505), sets the taken transmission destination as the next transmission destination in the RAM 103 (step S506), and terminates the present process. Thus, as shown in 606 of FIG. 6, image data is transmitted to the archiving destination (1), the user-designated destination (1), an archiving destination (2), a user-designated destination (2), an archiving destination (3), and a user-designated destination (3) in this order.

As described above in detail, according to the present embodiment, even when a plurality of transmission jobs are designated (a plurality of designations to which image data is to be transmitted are set), image data can be preferentially transmitted to a user-designated destination related to a previously input transmission job.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-297682 filed Dec. 28, 2009, which is hereby incorporated by reference herein in its entirety.

What is claimed is:

1. An image data transmission apparatus comprising:
a generation unit configured to generate image data;
a first setting unit configured to set a destination indicative of an archiving destination that manages the image data;
a first transmission unit configured to transmit the image data generated by said generation unit to the archiving destination set by said first setting unit;
a second setting unit configured to set a destination to which the image data is to be transmitted;
a second transmission unit configured to transmit the image data generated by said generation unit to the destination set by said second setting unit; and
a control unit configured to, when the image data has been successfully transmitted to the archiving destination by said first transmission unit, cause said second transmission unit to transmit the image data to the destination.

2. An image data transmission apparatus according to claim 1, wherein when transmission of the image data to the archiving destination by said first transmission unit has been canceled, or when an error occurs during the transmission of the image data to the archiving destination, said control unit inhibits said second transmission unit from transmitting the image data to the destination.

3. An image data transmission apparatus according to claim 2, further comprising a notification unit configured to, when said second transmission unit has not transmitted the image data to the destination, notify a user who has set the destination using said second setting unit that the image data has not been transmitted.

4. An image data transmission apparatus according to claim 1, further comprising a third setting unit configured to make a setting that the archiving destination is in an error state,
wherein when said third setting unit makes a setting that the archiving destination is in an error state, said control unit inhibits said first transmission unit from transmitting the image data to the archiving destination.

5. An image data transmission apparatus according to claim 4, wherein when an error occurs during the transmission of the image data to the archiving destination by said first setting unit, said third setting unit makes a setting that the archiving destination is in an error state.

6. An image data transmission apparatus according to claim 1, wherein when said second setting unit sets a plurality of destinations to which the image data is to be transmitted, said control unit—gives higher priority to transmission of the image data to the destination by said second transmission unit than to transmission of the image data to the archiving destination by said first transmission unit.

7. An image data transmission apparatus according to claim 1, further comprising a fourth setting unit configured to set whether priority is given to transmission of the image data to the archiving destination by said first transmission unit,
wherein when said fourth setting unit sets that priority is not given to transmission of the image data to the archiving destination, said control unit—causes said first transmission unit to transmit the image data to the archiving destination after causing said second transmission unit to transmit the image data to the destination.

8. A control method for an image data transmission apparatus having a generation unit that generates image data, comprising:
a first setting step of setting a destination indicative of an archiving destination that manages the image data;
a first transmission step of transmitting the image data generated by the generation unit to the archiving destination set in said first setting step;
a second setting step of setting a destination to which the image data is to be transmitted;
a second transmission step of transmitting the image data generated by the generation unit to the destination set in said second setting step; and
a control step of, when the image data has been successfully transmitted to the archiving destination in said first transmission step, transmitting the image data to the destination in said second transmission step.

9. A computer-readable non-transitory storage medium storing a program for causing a computer to execute a control method for an image data transmission apparatus having a generation unit that generates image data, the control method comprising:
a first setting step of setting a destination indicative of an archiving destination that manages the image data;
a first transmission step of transmitting the image data generated by the generation unit to the archiving destination set in the first setting step;
a second setting step of setting a destination to which the image data is to be transmitted;
a second transmission step of transmitting the image data generated by the generation unit to the destination set in the second setting step; and
a control step of, when the image data has been successfully transmitted to the archiving destination in the first transmission step, transmitting the image data to the destination in the second transmission step.
